(19) United States
(12) Patent Application Publication
(10) Pub. No.: US 2025/0322577 A1
(43) Pub. Date: Oct. 16, 2025

(54) PHOTOGRAPHING AND PRINTING SYSTEM BASED ON AR

(71) Applicant: Shenzhen Binbin Youli Technology Co., Ltd., Shenzhen (CN)

(72) Inventor: Yuanbin QIU, Shenzhen (CN)

(21) Appl. No.: 18/672,424

(22) Filed: May 23, 2024

(30) Foreign Application Priority Data
Apr. 11, 2024 (CN) 202410451127.9

(51) Int. Cl. G06T 13/40; G06K 15/02; G06T 7/246; G06T 7/277; G06T 19/00; G06V 10/40; G06V 10/74; G06V 20/20; G09B 11/00

(52) U.S. Cl. CPC G06T 13/40; G06K 15/1859; G06T 7/248; G06T 7/277; G06T 19/00; G06V 10/40; G06V 10/761; G06V 20/20; G06T 2207/10016; G09B 11/00

(57) ABSTRACT

A photographing and printing system based on augmented reality (AR) is provided. The system includes a video collector, an AR scanner, an image processor, a data processor, a rendering engine, a printer. The image processor includes an image recognizing module, an image tracking module, an image matching module, and a virtual information superimposing module. The video collector collects the image information from the images, the video collector transmits collected image information to the image processor through the AR scanner to process the images, thereby obtaining processed image information, the image processor transmits the processed image information to the data processor, and the data processor controls the printer through the rendering engine. The photographing and printing system with high recognition accuracy, multifunction and easy operation can generate animation effects, improve children's painting education, and stimulate children's creativity and imagination.

### TECHNICAL FIELD

The disclosure relates to the technic field of augmented reality (AR) photography, and particularly to a photographing and printing system based on AR.

### BACKGROUND

Augmented reality (AR) photography allows users to choose a virtual background when taking photos, and integrate the photos with the real environment to produce a novel and interesting effect.

Users can choose various virtual backgrounds, such as landscapes, cities, science fiction, etc., through mobile applications or specific AR devices, to make their photos more vivid and interesting.

However, existing AR photography technology is unable to achieve children's graffiti painting through the generation of animations for educational purposes, making it convenient for children to learn painting education.

Photographing and printing based on AR for children's graffiti is an innovative educational and entertainment method that combines traditional painting and augmented reality technology. Through this method, children can freely doodle on paper and use the accompanying AR application to take photos, watching their created patterns or scenes presented dynamically and interactively on the screen.

This technology combines virtual and real worlds, stimulating children's creativity and imagination while also providing more vivid and interesting experiences. In addition, by combining graffiti works with AR technology, it can also help children understand how digital content interacts with physical space.

### SUMMARY

The main purpose of the disclosure is to provide a photographing and printing system based on augmented reality (AR) with high recognition accuracy, the ability to generate animation effects, improve children's painting education, stimulate children's creativity and imagination, diverse functions, and more convenient and flexible operation.

In order to achieve above purpose, a photographing and printing system based on AR is provided, which includes a video collector, an AR scanner, an image processor, a data processor, a rendering engine, a printer. The image processor includes an image recognizing module, an image tracking module, an image matching module, a virtual information superimposing module. The video collector is configured to collect image information. The AR scanner is configured to scan and recognize the image information through an augmented reality application. the image processor is configured to receive the image information from the AR scanner and process the image information to obtain processed image information, and transmit the processed image information to the data processor. The image recognizing module is configured to recognize the image information, and control the image matching module through the image tracking module. The image tracking module is configured to real-time track the image information. The image matching module is configured to match the image information with virtual information to obtain a matched virtual information. The virtual information superimpose is configured to superimpose the matched virtual information on the image information and obtain superimposed virtual information as the processed image information, and transmit the superimposed virtual information to the data processor.

The video collector is configured to collect the image information from the images, the video collector is configured to transmit collected image information to the image processor through the AR scanner to process the images, thereby obtaining processed image information, the image processor is configured to transmit the processed image information to the data processor, and the data processor is configured to control the printer through the rendering engine.

The image processor is configured to transmit the processed image information to the image recognizing module, thereby obtaining identified image information, the image recognizing module is configured to control the image matching module through the image tracking module; and the virtual information superimposing module is configured to transmit superimposed virtual information to the image processor.

In an embodiment, the rendering engine includes an AR engine module, the AR engine module is configured to identify the superimposed virtual information to obtain identified superimposed virtual information.

In an embodiment, the rendering engine further includes a virtual information matching module and an attitude estimating module. The virtual information matching module is configured to match the identified superimposed virtual information with pre-defined virtual information to determine an augmented reality element, and superimpose the augmented reality element on the identified superimposed virtual information to obtain augmented reality virtual information. The attitude estimating module is configured to calculate transformation parameters for superimposing the augment reality element.

In an embodiment, the virtual information matching module includes a data preprocessing module, a feature extracting module, a similarity calculation module, a matching algorithm module. The data preprocessing module is configured to preprocess the identified superimposed virtual information to obtain preprocessed superimposed virtual information, and is configured to control the similarity calculation module through the feature extracting module. The feature extracting module is configured to extract image information features of the preprocessed superimposed virtual information. The similarity calculation module is configured to determine a similarity between the image information features of the preprocessed superimposed virtual information and image information features of the pre-defined virtual information based on a similarity measurement method, and is configured to control the matching algorithm module. The matching algorithm module is configured to determine matching information between the identified superimposed virtual information with the pre-defined virtual information based on the similarity. The virtual information matching module is configured to transmit the matching information to the data preprocessing module.

In an embodiment, the similarity calculation module includes one of a cosine similarity module, a Euclidean distance module, or an edit distance module.

In an embodiment, the attitude estimating module is configured to perform a Kalman filter algorithm, and the Kalman filter algorithm is configured to recursively estimate system state variables of the photographing and printing system and adjust the system state variables based on a measurement value obtained by a sensor of the photographing and printing system to improve calculation accuracy of the attitude estimating module.

In an embodiment, the attitude estimating module is configured to perform a visual inertia fusion equation algorithm, the visual inertia fusion equation algorithm includes a system state equation, a measurement update equation, a Kalman gain equation, a prediction step equation, an updating step equation and a final result equation as follows:
wherein the system state equation is expressed as follows:

$$\$x\_k = f ( x\_ \{ k - 1 \} , u\_k ) + w\_k\$ ,$$

where $x_k$ represents a state vector of the photographing and printing system at time $k$, $u_k$ represents a control input vector, $f(\cdot)$ represents a dynamics model function of the photographing and printing system, and $w_k$ represents a process noise;
the measurement update equation is expressed as follows:

$$\$z\_k = h ( x\_ \{ k \} ) + v\_ \{ k \} \$ ,$$

where z_k$ represents a measurement value measured by a sensor of the photographing and printing system, the measurement value comprises camera data and inertial measurement unit (IMU) data, h⋅) represents a function for projecting the state vector $x_k$ to a measurement vector, and v(k) represents a measurement noise;
the Kalman gain equation is expressed as follows:

$$\$ = P \hat{} - \backslash H \hat{} T \backslash cdot ( H \backslash cdot P \backslash cdot H \hat{} T R ) \hat{} \{ - 1 ;$$

the prediction step equation is expressed as follows:

$$\$ \backslash hat \{ x \} k \hat{} -= f ( \{ x \} \{ k - 1 u\_ \{ k \} ) \$ , \$ \backslash hat \{ P \} k \hat{} -= F \backslash hat \{ P \} \{ t - 1 \} F \hat{} T + Q \$ ;$$

the updating step equation is expressed as follows:

$$\$ \backslash tilde \{ y \} \_t = z\_t = h ( \backslash hat \} \_t \hat{} \{ - \} ) \$ , \$ \{ \} = HP\_t \hat{} \{ - \} H \hat{} \{ T \} + R \$ ;$$

the final result equation is expressed as follows:
an updated state estimate mean is:

$$bar x = \backslash bar xmathbf K \backslash tilde y \$ ,$$

an updated error covariance matrix is:

$$\$ \backslash P = ( I - KHbar P \$ .$$

In an embodiment, the rendering engine includes a modeling and animation production module, a keyframe setting module, an interpolation calculation module, a skeleton system and skinning system module and a lighting effect processing module. The modeling and animation production module is configured to model the augmented reality virtual information and create an animation, and is configured to control the interpolation calculation module through the keyframe setting module. The keyframe setting module is configured to process the animation to obtain the animation information. The interpolation calculation module is configured to analyze and process a state of the animation information, and is configured to control the lighting effect processing module through the skeleton system and skinning system module. The skeleton system and skinning system module is configured to control simulated characters of the animation information. The lighting effect processing module is configured to generate lighting effects.

In an embodiment, the interpolation calculation module comprises a linear interpolation calculation module or a Bezier curve calculation module.

In an embodiment, the linear interpolation calculation module is configured to perform linear interpolation calculation for a key frame A and a key frame B corresponding to a time t₁ and a time t₂, respectively, and a formula for the linear interpolation calculation is as follows:

$$[ \backslash text \{ InterpolatedValue \} = ( 1 - \backslash frac \{ t - t 1 \} \{ t 2 - t 1 \} ) * Value\_A + ( \backslash frac \{ t - t 1 \} \{ t 2 - t \} ) * Value\_B ] ,$$

where the InterpolatedValue represents an attribute value corresponding to a time t between the time t₁ and the time t₂ based on time proportion.

The beneficial effects of the disclosure are as follows: a photographing and printing system based on AR is provided. The photographing and printing system transmits the image information collected by the video collector to the image processor through the AR scanner. The image processor transmits the processed image information to the data processor, and the data processor controls the printer through the rendering engine. The photographing and printing system can generate animation effects, stimulate children's creativity and imagination, integrate education with entertainment, provide real-time feedback and guidance, and improve children's painting education. In addition, the photographing and printing system based on AR has high AR recognition accuracy, diverse functions, convenient use, and is suitable for widespread promotion.

### BRIEF DESCRIPTION OF DRAWING

In order to provide a clearer explanation of the embodiments of the disclosure or the technical solutions in the related art, a brief introduction will be given below to the attached drawings required in the embodiments or description in related art. It is evident that the attached drawings in the following description are only some embodiments of the disclosure. For those skilled in the art, other accompanying drawings can be obtained based on the structures shown in these drawings without creative labor.

FIG. 1 illustrates a schematic system block diagram of a photographing and printing system based on AR according to an embodiment of the disclosure.

FIG. 2 illustrates a schematic block diagram of a rendering engine of the photographing and printing system based on AR according to an embodiment of the disclosure.

FIG. 3 illustrates a schematic block diagram of a virtual information matching module of the photographing and printing system based on AR according to an embodiment of the disclosure.

FIG. 4 illustrates a schematic block diagram of another rendering engine of the photographing and printing system based on AR according to an embodiment of the disclosure.

The implementation, functional characteristics, and advantages of the disclosure will be further explained in conjunction with the embodiment, with reference to the attached drawings.

### DETAILED DESCRIPTION OF EMBODIMENTS

The following will provide a clear and complete description of the technical solution in the embodiment of the disclosure, in conjunction with the attached drawings. Apparently, the described embodiment is only a part of the embodiments of the disclosure, not all of them. Based on the embodiment in the disclosure, all other embodiments obtained by those skilled in the art without creative labor fall within the scope of protection of the disclosure.

It should be noted that all directional indications (such as up, down, left, right, front and back) in the embodiment of the disclosure are only used to explain the relative position relationship and motion situation between components in a specific posture (as shown in the figures). If the specific posture changes, the directional indication also changes accordingly.

In the description of the disclosure, it should be noted that unless otherwise specified and limited, the terms “connected” and “fixed” should be understood broadly, for example, it can be fixed connection, detachable connection, or integral connection. And it can be a mechanical connection or an electrical connection. It can be directly connected or indirectly connected through an intermediate media. It can be the internal connection between two components or the interaction relationship between two components, unless otherwise specified. For those skilled in the art, the specific meaning of the above term in the disclosure can be understood in specific circumstances.

Furthermore, in the disclosure, descriptions related to “first” and “second” are only used for descriptive purposes and cannot be understood as indicating or implying their relative importance or implying the number of indicated technical features. Therefore, the features limited to “first” and “second” can explicitly or implicitly include at least one of these features. In addition, the technical solutions between various embodiments can be combined with each other, but must be based on what those skilled in the art can achieve. When the combination of technical solutions is contradictory or impossible to achieve, it should be considered that the combination of such technical solutions does not exist and is not within the scope of protection required by the disclosure.

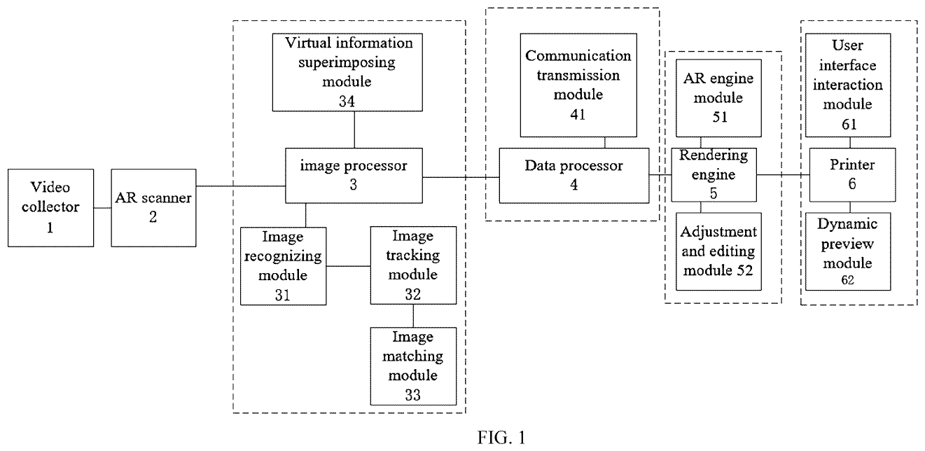

As shown in FIG. 1, a photographing and printing system based on augmented reality (AR) is provided, which includes a video collector 1, an AR scanner 2, an image processor 3, a data processor 4, a rendering engine 5, a printer 6. The image processor 3 includes an image recognizing module 31, an image tracking module 32, an image matching module 33, a virtual information superimposing module 34. The video collector 1 is configured to collect image information, the AR scanner 2 is configured to scan and recognize the image information through an augmented reality application, the image processor 3 is configured to receive the image information from the AR scanner 2 and process the image information to obtain processed image information, and transmit the processed image information to the data processor 4, the image recognizing module 31 is configured to recognize the image information, and control the image matching module 33 through the image tracking module 32, the image tracking module 32 is configured to real-time track the image information, the image matching module 33 is configured to match the image information with virtual information to obtain a matched virtual information, the virtual information superimposing module 34 is configured to superimpose the matched virtual information on the image information and obtain superimposed virtual information as the processed image information, and transmit the superimposed virtual information to the data processor 4, the data processor 4 is configured to transmit the processed image information to the rendering engine 5, and control the printer 6 through the rendering engine 5, the rendering engine 5 is configured to receive the processed image information from the data processor 4 and convert the processed image information into animation information, and the printer 6 is configured to print and output the animation information.

The video collector 1 is configured to collect the image information from the images, the video collector is configured to transmit collected image information to the image processor 3 through the AR scanner 2 to process the images, thereby obtaining processed image information, the image processor 3 is configured to transmit the processed image information to the data processor 4, and the data processor 4 is configured to control the printer 6 through the rendering engine 5.

The image processor 3 is configured to transmit the processed image information to the image recognizing module 31, thereby obtaining identified image information, the image recognizing module 31 is configured to control the image matching module 33 through the image tracking module 32. The virtual information superimposing module 34 is configured to transmit superimposed virtual information to the image processor 3.

In an embodiment, the photographing and printing system of the disclosure may collect image information of a pattern graffiti of a child through the video collector 1. For example, the graffiti pattern is a fish. Then, the collected image information of the fish is transmitted to the image processor 3 through the AR scanner 2 to process the collected image information by the image processor 3 to thereby obtain the processed image information. Then, the processed image information is transmitted to the data processor 4 to make the data processor 4 transmit the processed image information to the rendering engine 5 to render the processed image information to thereby generate a dynamic fish pattern, and the dynamic fish pattern is printed out through the printer 6.

In an embodiment, the video collector 1 is a camera, and the camera can be disposed in a mobile phone, a tablet, or an AR camera. The AR scanner 2 is configured to recognize and scan a selected graffiti pattern, and superimpose the virtual information around the selected graffiti pattern. The AR scanner 2 is usually represented by a dashed rectangle or other shape, for indicating a position on the screen where the user can perform scanning operations, and the AR scanner 2 includes a recognition algorithm module. The recognition algorithm is configured to perform a specific algorithm to identify a target object, and thus key points, grids, or other auxiliary elements will be displayed in a box diagram.

The specific algorithm includes a feature point matching algorithm, a camera positioning algorithm, and a point cloud registration algorithm.

For the feature point matching algorithm, in the image processing, feature points are unique and easily recognizable positions in the image. By comparing the feature points in two images and using various distance or similarity measures to determine the degree of matching between them.

For the camera positioning algorithm, that is, for AR applications, camera positioning is a crucial part. By combining environmental information captured by the camera, sensor data, and pre-defined models or landmarks, it is possible to accurately determine the camera's position and direction in three-dimensional (3D) space.

For the point cloud registration algorithm, when it comes to obtaining surface information of objects from multiple perspectives (such as 3D scanning), it is necessary to register point cloud data obtained from different perspectives, that is, to find the best match between them and convert them into a global coordinate system.

In the embodiment, the rendering engine 5 utilizes computer graphics technology to accurately superimpose and present virtual elements on real-world scenes.

The rendering engine 5 is an important component of computer graphics, mainly responsible for converting data generated by program into visual images or animations. The rendering engine 5 can implement the following functions:
a geometric processing function, which processes and transforms input geometric information, such as translation, rotation, scaling, and other operations;
a rasterization function, which projects objects in the 3D space onto a two-dimensional (2D) screen and determines what color in each pixel of the 2D screen should display;
a shader function, which defines how to give a vertex or pixel shading, and includes vertex shaders and pixel shaders;
a texture mapping function, which maps texture to the surface of objects to increase realism, and performs corresponding calculations during the rendering process;
a lighting and shadowing function, which simulates real-world lighting effects by considering factors such as light source position and material properties, and generates realistic shadow effects;
a deep testing and occlusion removal function, which ensures the correct presentation of the front and back relationships, avoiding unnecessary areas from being covered;
an anti-aliasing function; and
an environmental reflection function.

In the embodiment, the rendering engine 5 includes an AR engine module 51, the AR engine module 51 is configured to identify the superimposed virtual information.

The AR engine module 51 is designed to handle the interaction between virtual elements and the real world, ensuring that the augmented reality effect can be accurately displayed on the recognized graffiti patterns.

The AR engine module 51 also includes augmented reality effects: superimposing various virtual elements such as animation and audio on the identified graffiti, making the entire work more vivid and interactive.

In the embodiment, the rendering engine 5 can further include an adjustment and editing module 52, the adjustment and editing module 52 is used to adjust and edit augmented reality effects as needed, ensuring that the final presentation effect meets expectations.

In the embodiment, the printer 6 can serve as a graffiti work with augmented reality effects that users can choose to print out when they are satisfied with what they see. The printer 6 can also be connected to a printer device and complete the final output steps to obtain a paper layout displaying the artwork.

The printer 6 includes a user interface interaction module 61, which is used to select, edit, and preview graffiti works through the interface.

In the embodiment, the printer 6 includes a dynamic preview module 62, which is used to allow users to view augmented reality effects displayed on design drafts at different angles and under different lighting conditions through a mobile device screen, as so to better understand what the final artwork can be look like.

In the embodiment, the data processor 4 further includes a communication transmission module 41, and the communication transmission module 41 can utilize a wired communication method or a wireless communication method. The communication transmission module 41 is used to receive external information or send generated pattern information to remote devices for convenient use.

In an embodiment, as shown in FIG. 2, the rendering engine 5 further includes a virtual information matching module 53 and an attitude estimating module 54. The virtual information matching module 53 is configured to match the identified superimposed virtual information with pre-defined virtual information to determine an augmented reality element, and superimpose the augmented reality element on the identified superimposed virtual information to obtain augmented reality virtual information. The attitude estimating module 54 is configured to calculate transformation parameters for superimposing the augment reality element.

The virtual information matching module 53 can match the identified graffiti patterns with the pre-defined virtual information to determine which augmented reality elements should be superimposed.

The attitude estimating module 54 can calculate the transformation parameters required for correctly projecting augmented reality element based on the position and angle of the graffiti pattern in the space.

In an embodiment, as shown in FIG. 3, the virtual information matching module 53 includes a data preprocessing module 531, a feature extracting module 532, a similarity calculation module 533, a matching algorithm module 534. The data preprocessing module 531 is configured to preprocess the identified superimposed virtual information to obtain preprocessed superimposed virtual information, and is configured to control the similarity calculation module through the feature extracting module. The feature extracting module 532 is configured to extract image information features of the preprocessed superimposed virtual information. The similarity calculation module 533 is configured to determine a similarity between the image information features of the preprocessed superimposed virtual information and image information features of the pre-defined virtual information based on a similarity measurement method, and is configured to control the matching algorithm module. The matching algorithm module 534 is configured to determine matching information between the identified superimposed virtual information with the pre-defined virtual information based on the similarity, and the virtual information matching module is configured to transmit the matching information to the data preprocessing module.

In the embodiment, the data preprocessing module 531 first standardizes, cleans, and converts input data from different formats or sources for post-processing purposes. The feature extracting module 532 extracts meaningful and comparable features from the original data, such as keyword extraction in text and image feature description. The similarity calculation module 533 calculates the similarity degree between different groups based on the selected similarity measurement method (such as a chord similarity and an editing distance). The matching algorithm module 534 is based on the calculated similarity degree between samples, and matches the related samples under the consistency bundle to generate the final result.

The similarity calculation module 533 is an important component of the virtual information matching system, used to measure the degree of similarity between two objects. In the similarity calculation module 533, various similarity measurement methods are usually used to compare and evaluate the similarity between data of objects.

In the embodiment, the similarity calculation module 533 includes one of a cosine similarity module, a Euclidean distance module, or an edit distance module.

The cosine similarity module is mainly used to measure the angle relationship between documents or feature vectors in a vector space model with a value range from −1 to 1.

The Euclidean distance module represents the difference between two points by measuring their straight-line distance, with smaller values indicating closer proximity.

The edit distance module (e.g. a Levenshtein distance module) is used to measure the minimum number of insertion, deletion, or substitution operations required to convert sequential data such as strings into another sequence.

In embodiment, the attitude estimating module 54 is configured to perform a Kalman filter algorithm, and the Kalman filter algorithm is configured to recursively estimate system state variables of the photographing and printing system and adjust the system state variables based on a measurement value obtained by a sensor of the photographing and printing system to improve calculation accuracy of the attitude estimating module.

The attitude estimating module 54 is configured to further incorporate a quaternion rotation representation method, which employs quaternions to characterize rotational operations, thereby circumventing the issue of gimbal lock and simplify the complexity.

The quaternion rotation representation method is used to describe the rotation of an object in 3D space, and its formular form is:

$q=w+xi+yj+zk$, where w is a real part of the quaternion, and $w, x, y, z$ is an imaginary part.

In the embodiment, the attitude estimating module 54 is configured to perform a visual inertia fusion equation algorithm, the visual inertia fusion equation algorithm comprises a system state equation, a measurement update equation, a Kalman gain equation, a prediction step equation, an updating step equation and a final result equation as follows:

the system state equation is expressed as follows:

$$\$x\_k = f ( x\_ \{ k - 1 \} , u\_k ) + w\_k\$ ,$$

where $x_k$ represents a state vector of the photographing and printing system at time $k$, $u_k$ represents a control input vector, $f(\cdot)$ represents a dynamics model function of the photographing and printing system, and $w_k$ represents a process noise;
the measurement update equation is expressed as follows:

$$\$z\_k = h ( x\_ \{ k \} ) + v\_ \{ k \} \$ ;$$

where z_k$ represents a measurement value measured by a sensor of the photographing and printing system, the measurement value comprises camera data and inertial measurement unit (IMU) data, h⋅) represents a function for projecting the state vector $x_k$ to a measurement vector, and v(k) represents a measurement noise;
the Kalman gain equation is expressed as follows:

$$\$ = P \hat{} - \backslash H \hat{} T \backslash cdot ( H \backslash cdot P \backslash cdot H \hat{} T R ) \hat{} \{ - 1 ,$$

the prediction step equation is expressed as follows:

$$\$ \backslash hat \{ x \} k \hat{} - = f ( \{ x \} \{ k - 1 u\_ \{ k \} \} \$ , \$ \backslash hat \{ P \} k \hat{} - = F \backslash hat \{ P \} \{ t - 1 \} F \hat{} T + Q \$ ;$$

the updating step equation is expressed as follows:

$$\$ \backslash tilde \{ y \} \_t = z\_t - h ( \backslash hat \} \_t \hat{} \{ - \} ) \$ , \$ \{ \} = HP\_t \hat{} \{ - \} H \hat{} \{ T \} + R \$ ;$$

the final result equation is expressed as follows:
an updated state estimate mean is:

$$bar x = ∖ bar xmathbf K ∖ tilde y \$ ;$$

an updated error covariance matrix is:

$$\$ \backslash P = ( I - KHbar P \$ .$$

The visual inertial fusion algorithm, when integrating camera data and IMU (inertial measurement unit) data, must account for issues such as temporal synchronization between the two data sources and alignment of their respective coordinate systems. The fusion process entails a variety of linear algebraic operations and probabilistic inference methods to ensure accurate and robust integration of the heterogeneous data sets.

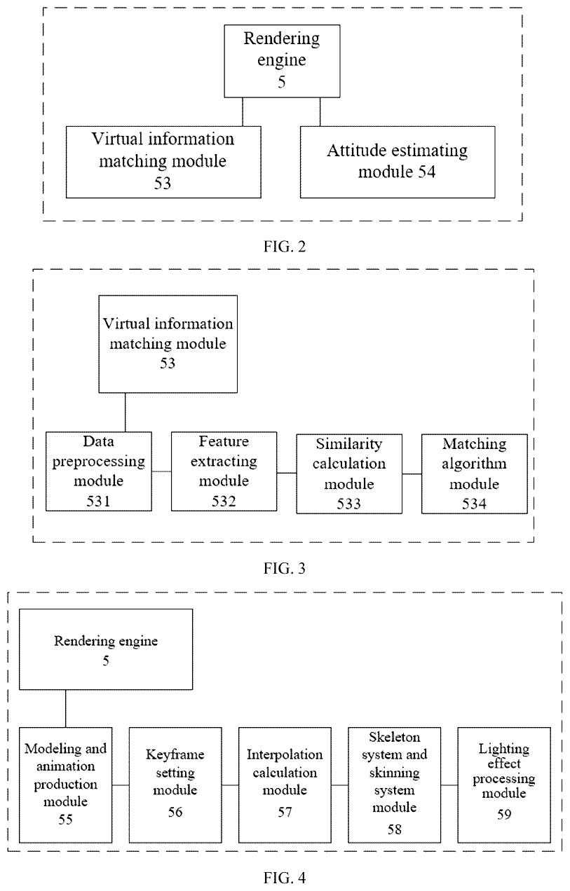

In an embodiment, as shown in FIG. 4, the rendering engine includes a modeling and animation production module 55, a keyframe setting module 56, an interpolation calculation module 57, a skeleton system and skinning system module 58 and a lighting effect processing module 59. The modeling and animation production module 55 is configured to model the augmented reality virtual information and create an animation, and is configured to control the interpolation calculation module through the keyframe setting module. The keyframe setting module 56 is configured to process the animation to obtain the animation information. The interpolation calculation module 57 is configured to analyze and process a state of the animation information, and is configured to control the lighting effect processing module through the skeleton system and skinning system module. The skeleton system and skinning system module 58 is configured to control simulated characters of the animation information. The lighting effect processing module 59 is configured to generate lighting effects.

The rendering engine 5 transforming the image information into the animation information includes the following steps:
1. 3D models and animation are created through the modeling and animation production module 55, the models include characters, scenes, or other objects;
2. keyframe is set through the keyframe setting module 56, keyframes are special frames that define significant changes in the state of the animation. The keyframes are used to specify the position, rotation, and scaling attributes of objects at different points in time;
3. interpolation computation is performed through the interpolation calculation module 57, the rendering engine 5 calculates the state of objects between the keyframes to ensure a smooth and natural transition throughout the animation;
4. the skeleton system and skinning system module 58 is used for applying character poses, which involves binding the 3D models to a skeleton to ensure accurate and responsive movement to various actions;
5. light effect processing is performed through the lighting effect processing module 59, which generates appropriate lighting effects by determining the position, quality, and other attributes of light sources;
6. image information and the animation information are used to generate a continuous and vivid sequence of images, resulting in a complete and fluid visual effect presented to the user.

The skeleton system and skinning system module 58 includes a skeleton system and a skinning system.

The skeleton system, as referred to, is a virtual framework composed of a series of interconnected joints, which is utilized to control the posture, motion, and deformation of characters or objects. Each joint possesses its own rotational axis and a defined range of motion limitations. By adjusting the relative positions and rotational angles among the various joints, complex animation effects can be achieved. In the field of computer graphics, a hierarchical structure is used to represent a complete skeleton system.

The skinning system refers to connecting each vertex on the surface of the model to a specific part with a higher weight value (i.e. “skin”) as closely as possible to its influence, so that when the related parts move, the model can produce realistic and smooth changes This technology is mainly applied to situations such as character modeling that require muscle contraction and stretching.

In summary, in the process of generating animations in the disclosure, the appropriate quantity and layout are first designed and created, and then different types of constraint conditions are set according to the requirements, and interpolation methods are used to generate smooth and coherent running paths. Then, through skinning technology, the object is made more vibrant and flexible.

In the embodiment, the interpolation calculation module 57 includes a linear interpolation calculation module or a Bezier curve calculation module.

In the embodiment, the linear interpolation calculation module is configured to perform linear interpolation calculation for a key frame A and a key frame B corresponding to a time t₁ and a time t₂, respectively, and a formula for the linear interpolation calculation is as follows:

$$[ \backslash text \{ InterpolatedValue \} = ( 1 - \backslash frac \{ t - t 1 \} \{ t 2 - t 1 \} ) * Value\_A + ( \backslash frac \{ t - t 1 \} \{ t 2 - t \} ) * Value\_B ] ,$$

where the Interpolated Value represents an attribute value corresponding to a time t between the time t₁ and the time t₂ based on time proportion.

The system of the disclosure can be applied in AR cameras, as well as in smartphones or tablets. It is an innovative system that combines augmented reality technology with traditional photo printing. It achieves the combination of children's graffiti with AR photo taking and printing, creating a new method of education and entertainment. This system stimulates children's creativity and imagination, and also provides them with a more vivid and interesting drawing experience.

The above is only a specific embodiment of the disclosure and does not limit the scope of the patent of the disclosure. Any equivalent structural changes made using the description and drawings of the disclosure, or directly/indirectly applied in other related technical fields, are included in the scope of patent protection of the disclosure.

What is claimed is:

1. A photographing and printing system based on augmented reality (AR) comprising: a video collector, an AR scanner, an image processor, a data processor, a rendering engine, and a printer;
wherein the video collector is configured to collect image information;
the AR scanner is configured to scan and recognize the image information through an augmented reality application;
the image processor is configured to receive the image information from the AR scanner and process the image information to obtain processed image information, and transmit the processed image information to the data processor;
the data processor is configured to transmit the processed image information to the rendering engine, and control the printer through the rendering engine;
the rendering engine is configured to receive the processed image information from the data processor and convert the processed image information into animation information; and
the printer is configured to print and output the animation information;
wherein the image processor comprises an image recognizing module, an image tracking module, an image matching module, and a virtual information superimposing module;
wherein the image recognizing module is configured to recognize the image information, and control the image matching module through the image tracking module;
the image tracking module is configured to real-time track the image information;
the image matching module is configured to match the image information with virtual information to obtain a matched virtual information; and
the virtual information superimposing module is configured to superimpose the matched virtual information on the image information and obtain superimposed virtual information as the processed image information, and transmit the superimposed virtual information to the data processor.

2. The photographing and printing system based on the AR as claimed in claim 1, wherein the rendering engine comprises an AR engine module, the AR engine module is configured to identify the superimposed virtual information to obtain identified superimposed virtual information.

3. The photographing and printing system based on the AR as claimed in claim 2, wherein the rendering engine further comprises a virtual information matching module and an attitude estimating module;
wherein the virtual information matching module is configured to match the identified superimposed virtual information with pre-defined virtual information to determine an augmented reality element, and superimpose the augmented reality element on the identified superimposed virtual information to obtain augmented reality virtual information; and the attitude estimating module is configured to calculate transformation parameters for superimposing the augment reality element.

4. The photographing and printing system based on the AR as claimed in claim 3, wherein the virtual information matching module comprises a data preprocessing module, a feature extracting module, a similarity calculation module, a matching algorithm module;
wherein the data preprocessing module is configured to preprocess the identified superimposed virtual information to obtain preprocessed superimposed virtual information, and is configured to control the similarity calculation module through the feature extracting module; the feature extracting module is configured to extract image information features of the preprocessed superimposed virtual information; the similarity calculation module is configured to determine a similarity between the image information features of the preprocessed superimposed virtual information and image information features of the pre-defined virtual information based on a similarity measurement method, and is configured to control the matching algorithm module; and the matching algorithm module is configured to determine matching information between the identified superimposed virtual information with the pre-defined virtual information based on the similarity; and the virtual information matching module is configured to transmit the matching information to the data preprocessing module.

5. The photographing and printing system based on the AR as claimed in claim 4, wherein the similarity calculation module comprises one of a cosine similarity module, a Euclidean distance module, or an edit distance module.

6. The photographing and printing system based on the AR as claimed in claim 3, wherein the attitude estimating module is configured to perform a Kalman filter algorithm, and the Kalman filter algorithm is configured to recursively estimate system state variables of the photographing and printing system and adjust the system state variables based on a measurement value obtained by a sensor of the photographing and printing system to improve calculation accuracy of the attitude estimating module.

7. The photographing and printing system based on the AR as claimed in claim 3, wherein the attitude estimating module is configured to perform a visual inertia fusion equation algorithm, the visual inertia fusion equation algorithm comprises a system state equation, a measurement update equation, a Kalman gain equation, a prediction step equation, an updating step equation and a final result equation as follows:
wherein the system state equation is expressed as follows:
$$\$x\_k = f ( x\_ \{ k - 1 \} , u\_k ) + w\_k\$ ;$$
where $x_k$ represents a state vector of the photographing and printing system at time $k$, $u_k$ represents a control input vector, $f(\cdot)$ represents a dynamics model function of the photographing and printing system, and $w_k$ represents a process noise;
wherein the measurement update equation is expressed as follows:
$$\$z\_k = h ( x\_ \{ k \} ) + v\_ \{ k \} \$ ;$$
where z_k$ represents a measurement value measured by a sensor of the photographing and printing system, the measurement value comprises camera data and inertial measurement unit (IMU) data, h⋅) represents a function for projecting the state vector $x_k$ to a measurement vector, and v(k) represents a measurement noise;
wherein the Kalman gain equation is expressed as follows:
$$\$ = P \hat{} - \backslash H \hat{} T \backslash cdot ( H \backslash cdot P \backslash cdot H \hat{} T R ) \hat{} \{ - 1 ;$$
wherein the prediction step equation is expressed as follows:
$$\$ \backslash hat \{ x \} k \hat{} - = f ( \{ x \} \{ k - 1 u\_ \{ k \} \} \$ , \$ \backslash hat \{ P \} k \hat{} - = F \backslash hat \{ P \} \{ t - 1 \} F \hat{} T + Q \$ ;$$
wherein the updating step equation is expressed as follows:
$$\$ \backslash tilde \{ y \} \_t = z\_t - h ( \backslash hat \} \_t \hat{} \{ - \} ) \$ , \$ \{ \} = HP\_t \hat{} \{ - \} H \hat{} \{ T \} + R \$ ;$$
wherein the final result equation is expressed as follows:
an updated state estimate mean is: bar x=\bar xmathbf K\tilde y$; an updated error covariance matrix is: $\P=(I−KHbar P$.

8. The photographing and printing system based on the AR as claimed in claim 3, wherein the rendering engine further comprises a modeling and animation production module, a keyframe setting module, an interpolation calculation module, a skeleton system and skinning system module, and a lighting effect processing module;
wherein the modeling and animation production module is configured to model the augmented reality virtual information and create an animation, and is configured to control the interpolation calculation module through the keyframe setting module; the keyframe setting module is configured to process the animation to obtain the animation information; the interpolation calculation module is configured to analyze and process a state of the animation information, and is configured to control the lighting effect processing module through the skeleton system and skinning system module; the skeleton system and skinning system module is configured to control simulated characters of the animation information; and the lighting effect processing module is configured to generate lighting effects.

9. The photographing and printing system based on the AR as claimed in claim 8, wherein the interpolation calculation module comprises a linear interpolation calculation module or a Bezier curve calculation module.

10. The photographing and printing system based on the AR as claimed in claim 8, wherein the linear interpolation calculation module is configured to perform linear interpolation calculation for a key frame A and a key frame B corresponding to a time t₁ and a time t₂, respectively, and a formula for the linear interpolation calculation is as follows:
$$[ \backslash text \{ InterpolatedValue \} = ( 1 - \backslash frac \{ t - t 1 \} \{ t 2 - t 1 \} ) * Value\_A + ( \backslash frac \{ t - t 1 \} \{ t 2 - t \} ) * Value\_B ] ,$$
where the InterpolatedValue represents an attribute value corresponding to a time t between the time t₁ and the time t₂ based on time proportion.
